(19) United States
(12) Patent Application Publication
(10) Pub. No.: US 2025/0374414 A1
(43) Pub. Date: Dec. 4, 2025

(54) APPARATUS AND METHOD FOR OPTIMIZING AN OPTICAL ENERGY TRANSFER IN LASER PARTICLE ACCELERATION

(71) Applicant: Focused Energy Inc., Austin, TX (US)

(72) Inventor: Marc Zimmer, Darmstadt (DE)

(21) Appl. No.: 18/678,732

(22) Filed: May 30, 2024

(51) Int. Cl. H05H 15/00

(52) U.S. Cl. CPC H05H 15/00

(57) ABSTRACT

An apparatus for optimizing an optical energy transfer in laser particle acceleration, the apparatus comprising: an optical input for receiving a pulsed laser beam from a laser source; a primary mirror arranged in an optical path of the pulsed laser beam to reflect a main portion of the pulsed laser beam as main pulses; at least one secondary mirror arranged in the optical path of the pulsed laser beam to reflect a remaining portion of the pulsed laser beam as pre-pulses; and a moving device adapted to move the at least one secondary mirror relative to the primary mirror to vary an optical length for the pre-pulses compared to an optical length of the main pulses to allow the pre-pulses to arrive at the target before the main pulses to optimize the optical energy transfer to ions accelerated from the target.

### TECHNICAL FIELD

The present invention relates to an apparatus and a method for optimizing an optical energy transfer in laser particle acceleration and, in particular, to a method for increasing conversion efficiency of laser energy into kinetic energy of ions via high intensity laser particle acceleration.

### BACKGROUND

Laser particle acceleration is an emerging field with the promise of replacing conventional particle accelerators for certain applications. Laser ion acceleration utilizes ultra-short pulse lasers with high intensities above 10¹⁸ W/cm² to accelerate electrons and ions, predominantly protons. In this process a 10 ps to 1 fs long laser is directed onto a solid or liquid target in the range of 10 nm to 100 μm.

The ion generation can be achieved as follows. A direct acceleration of ions in a laser field would need intensities in the range of 10²⁴ W/cm² which is still out of reach for modern laser systems. Laser intensities of current system are about 10²² W/cm². Therefore, the laser energy is first transferred to hot electrons, e.g., via the ponderomotive heating followed by a subsequent laser-driven acceleration. The electrons are capable to accelerate ions via the generation of quasi-static electric fields on the rear target side. This method works if the density of the plasma is higher than the so-called critical density, which is the density below which a plasma is transparent and above which the plasma becomes opaque. At this density the natural resonance frequency of the plasma equals the laser frequency and allows a resonant coupling of the laser to the plasma.

For the acceleration of only electrons a less dense (below critical density) target material in a plasma state can be chosen to drive laser electron acceleration by the formation of density bubbles inside the plasma which follow the propagating laser beam and trap electrons and accelerate them to an energy of tens MeV to hundreds of MeV (e.g. between 1 MeV and 1 GeV or between 10 MeV and 500 MeV). Another method for electron acceleration is called direct laser acceleration in which a target slightly above or under the critical density is irradiated by the laser and plasma channels form in the target to accelerate the electrons in the target.

However, to serve as a replacement for conventional particle accelerators, the energy transfer from the laser to the ions is still not yet sufficient. Therefore, there is a demand for optimizing the optical energy transfer to accelerate the ions and electrons more effectively.

### SUMMARY OF THE INVENTION

At least some of the above-mentioned problems are solved by an apparatus according to claim 1, a method according to claim 12, and a machine-readable storage medium according to claim 16. The dependent claims refer to further advantageous realizations for the subject matters of the independent claims.

The present invention relates to an apparatus for optimizing an optical energy transfer in laser particle acceleration (e.g. ion and electron acceleration). The apparatus comprises: an optical input for receiving a pulsed laser beam from a laser source, a primary mirror arranged in an optical path of the pulsed laser beam to reflect a main portion of the pulsed laser beam as main pulses, at least one secondary mirror arranged in the optical path of the pulsed laser beam to reflect a remaining portion of the pulsed laser beam as pre-pulses, and a moving device. The moving device is adapted to move the at least one secondary mirror relative to the primary mirror to vary an optical length for the pre-pulses compared to an optical length of the main pulses to allow the pre-pulses to arrive at the target before the main pulses to optimize the optical energy transfer to ions or electrons accelerated from the target. In addition, the apparatus may have an optical output adapted to provide and/or to direct the pre-pulses and the main pulses to the target. Each of the pre pulses can be changed in intensity relative to the main pulse.

The change in arrival time and intensity relative to the main pulse modifies the plasma gradient in front of the target and is used to create a density profile that enhances the energy transfer of the laser to electrons and subsequently into ions.

It is understood that a laser source producing a pulsed laser beam will transmit multiple pulses into the apparatus with predetermined pulse rate set by the laser source (controlled by respective parameters). Each of these multiple pulses will give, for example, one main pulse and multiple pre-pulses may be generated in the apparatus. The number of pre-pulses will depend on the number of secondary mirrors, which may be arranged “upstream” of the primary mirror (with respect the light propagation direction). The number and timing and intensity of the pre-pulses for each main pulse may generate and shape a pre-plasma (before the target). The inventors have found that by shaping the generated pre-plasma the desired energy transfer from the laser to the ions such as protons is increased.

Optionally, the laser source is part of the apparatus. However, alternatively or additionally, an available laser source may be utilized to generate the pulsed laser beam. It is further understood that the optical length may be given by a distance that photons of the laser beam have to travel from the optical input to the optical output. Optionally, multiple primary mirrors may be formed in the apparatus, and one or more secondary mirrors may be associated with each of the multiple primary mirrors to split off respective pre-pulses. The moving device may change a position of each of the possibly multiple secondary mirrors independently and therewith control the timing of the pre-pulses, i.e. the times when they leave the apparatus compared to the respective main pulse.

Optionally, the at least one secondary mirror is semitransparent and is arranged to receive the pulsed laser beam from a first direction and to reflect the pre-pulses a second direction (e.g., different from the first direction). The laser light representing the main pulses may pass through the semitransparent secondary mirror(s) to propagate along a delay line formed between the primary mirror and the at least one secondary mirror. The primary mirror may reflect the main pulses in the second direction (or another direction). The moving device may be adapted to vary a length of the delay line. Depending on the length of the delay line, the main pulses and the pre-pulses can be reflected in separate optical paths (e.g. without overlap).

According to further embodiments multiple secondary mirrors may be arranged serially along the first direction to reflect the pre-pulses towards the target (possibly after reflections at further mirrors). Likewise, one or more (semitransparent) secondary mirrors can be formed in a parallel arrangement, i.e., they are spaced from the primary mirror in a direction of incidence of the pulsed laser beam and may be shifted in a direction parallel to the reflection surface of the primary mirror or may be shifted in a direction perpendicular to the direction of incidence.

Optionally, the apparatus further comprises an absorber arranged along one or more optical paths travelled by the pre-pulses. The absorber(s) may be adapted to adjust an intensity of the pre-pulses based on received control signals. Hence, the absorber(s) can be adjustable absorber and if there are more than one optical path for the pre-pulse multiples absorbers can be arranged at some or all of them.

Optionally, the at least one secondary mirror is opaque (to reflect all light). The pulsed laser beam may have a cross-sectional area which is larger than a cross-section of the at least one secondary mirror in the optical path of the pulsed laser beam (e.g., when viewed along the optical path such as the direction of incidence). The at least one secondary mirror may be formed such that its cross-sectional area has a value to achieve a desired intensity of the pre-pulses. It is understood that each of the secondary mirror can have a different geometry or size to generate different pre-pulses. The values that achieve the best technical effect (optimal energy transfer) can be determined by a simulation. It is understood that for opaque secondary mirrors a maximum intensity of the pre-pulses is set by the size of the secondary mirrors and may be lowered by optional (adjustable) absorber.

Optionally, the usage of adjustable absorbers for pre-pulse intensity can be exchanged with changing the light that is reflected by each pre-pulse mirror. This can be done by changing the reflectivity or by changing the area of the pre-pulse mirror that is present in the laser beam.

Optionally, the primary mirror reflects the main pulses in a direction of incidence of the pulsed laser beam (e.g., reflect light backward) or under a predetermined reflection angle. Likewise, the at least one secondary mirror may reflect the pre-pulses in the direction of incidence of the pulsed laser beam or in the predetermined reflection angle. In other words, the orientation of main mirror(s) and/or secondary mirror(s) relative to the optical path can be varied or selected as needed or desired. Again, the at least one secondary mirror can be opaque or semitransparent. As for the other embodiments, the pulsed laser beam can again have a cross-sectional area which larger than a cross-section of the at least one secondary mirror in the optical path of the pulsed laser beam.

Optionally, the at least secondary mirror comprises multiple secondary mirrors which are arranged in a cross-sectional area of the pulsed laser beam in front of one primary mirror so that the main pulses and the pre-pulses propagate along a same optical path. For example, the main pulses may have a larger cross-sectional area (lateral size) and pre-pulses may be laterally spaced from one another. The lateral size of each pre-pulse can thus be smaller than the main pulse. Even the sum of cross-sectional areas of all pre-pulses may be smaller than the cross-sectional area of the main pulse. The lateral areas/extension of the pre-pulses can be adjusted again to achieve a desired intensity and may optionally be determined using a simulation.

Optionally, the apparatus further comprises a control device. The control device can be adapted to control one or more of the following:
the source of the pulsed laser beam,
the moving device,
the absorber.

By this controlling at least one of the following can be adjusted or varied:
an intensity of the pulsed laser beam;
a frequency of pulses in the pulsed laser beam;
a delay between subsequent pulses (e.g. of the pulsed laser beam);
adjust a timing of arrival of the pre-pulses at the target
compared to the main pulse;
an intensity of the pre-pulses.

According to further embodiments, no absorber is present, but the pre-pulse intensity is set by how much of the secondary mirror is inside the main beam and therefore how much it reflects. For this, the moving device may be controlled to move the at least one secondary mirror parallel and/or perpendicular to a reflecting surface of the primary mirror.

The orientation of all secondary mirrors can such that the reflection angles of the laser light are the same or are different. Multiple primary mirrors may have each associated secondary mirrors arranged in front of them within the optical path.

Optionally, the apparatus further includes the target adapted to release ions or electrons upon being hit by the pulsed laser beam. Moreover, the apparatus may include a spectrum analyzer adapted to determine a spectrum of the released ions. The spectrum analyzer may comprise or may be a detector and may be configured to determine an energy and/or an intensity of the ions or electrons or x-rays or gamma rays (number per second). The ions may be any positively charged nucleus. However, also electrons can be accelerated by the apparatus. Thus, the ions may also cover electrons. Moreover, the accelerated ions may subsequently be utilized to generate and accelerate neutron or for other purposes.

Optionally, the apparatus further includes a neural network machine adapted to increase the optical energy transfer in the laser ion acceleration by receiving as input one or more of the following:
the determined spectrum of the released ions or electrons or high energy photons,
parameters from the laser source characterizing the pulsed laser beam,
a position and an intensity of the pre-pulses or corresponding mirror and/or absorber positions

and provide as output one or more of the following:
improved parameters for the laser source,
control signals to control the moving device,
control signals to control the adjustable absorber.

Optionally, the neural network machine is trained to increase the optical energy transfer by preferring multiple pre-pulses for each main pulse and is trained to optimize an intensity and delay for some or each pre-pulse to achieve an electron density distribution near a critical electron density in front of the target (e.g., as a flat distribution) for longer ranges than possible with a single pre-pulse.

Concretely, the training may rely on labeled training data by iteratively adjusting the parameters of the neural network to minimize, for example, a defined loss function. For this, various forms for learnings can be implemented: supervised learning, unsupervised learning, reinforcement learning etc.

Embodiments relate also to a particle accelerator, which comprises:
a laser source adapted to generate a pulsed laser beam;
an optical input for receiving the pulsed laser beam from the laser source;
a primary mirror arranged in an optical path of the pulsed laser beam to reflect a main portion of the pulsed laser beam as main pulses;
at least one secondary mirror arranged in the optical path of the pulsed laser beam to reflect a remaining portion of the pulsed laser beam as pre-pulses; and
a target arranged to receive the pre-pulses and the main pulses to generate ion.

Optionally, the particle accelerator includes a focusing device like a parabola or a lens to focus the laser beam on the target.

The target may be liquid water or may have a deuterated material or a foil material and the ions may be especially protons. Other forms of the target could be cryogenic hydrogen jets or ribbons, or band or tape targets out of solid materials or foil targets.

Embodiments relate also to a method for optimizing an optical energy transfer in laser particle acceleration. The method may include the steps of:
receiving a pulsed laser beam from a laser source;
reflecting, by a primary mirror arranged in an optical path of the pulsed laser beam, a main portion of the pulsed laser beam as main pulses;
reflecting, by at least one secondary mirror arranged in the optical path of the pulsed laser beam, a remaining portion of the pulsed laser beam as pre-pulses; and
moving, by a moving device, the at least one secondary mirror relative to the primary mirror to vary an optical length for the pre-pulses compared to an optical length of the main pulses to allow the pre-pulses to arrive at the target before the main pulses to optimize the optical energy transfer to ions accelerated from the target.

Optionally, the method includes the further step of changing the pre-pulse intensity of each pre-pulse separately (e.g., by moving the respective secondary mirrors accordingly in and out of the main beam).

Optionally, the step of reflecting the remaining portion includes a step of reflecting multiple pre-pulses by multiple secondary mirrors, wherein the multiple pre-pulses may have different temporal distances to the main pulse or may have different intensities from one another. By this, multiple pre-pulses can be introduced into the laser contrast with adjusted temporal distances to the main pulse and/or with adjusted intensities to enhance a laser absorption in the laser-driven ion acceleration. This increases the conversion efficiency and peak particle energy.

Optionally, the method further includes a step of increasing (or maximizing or optimizing) a conversion efficiency by using a particle detector as a feedback loop combined with an optimization algorithm or neuronal network machine to scan the parameter space and optimize the parameters for peak performance automatically. For example, the moving device and/or the adjustable absorber may be controlled accordingly to achieve an optimal timing and/or magnitude for the pre-pulses.

Similarly, also a size and/or transparency of secondary mirrors may be selected accordingly to ensure an optimal intensity of the pre-pulses. According to embodiments, a simulation may be utilized to find out optimal values for the sizes and/or transparencies of the secondary mirrors to achieve the optimal or maximal energy transfer. This simulation may likewise be utilized to find starting values for the control of the moving device and/or the absorber(s). According to further embodiments, this simulation is used to generate training data to train a given neural network. The training data associate for each input value a corresponding result obtained by the simulation.

Optionally, the method further includes a training of the neural network machine. During this training shifts in a performance of the parameters of the laser source and an interaction of the pre-pulses and the main pulses with a plasma generated at the target can be detected. At least one of the following can be performed:
detecting emitted gamma radiation,
detecting emitted plasma radiation,
detecting a laser near field,
detecting a laser far field,
changing a pulse shape of the pulsed laser beam,
changing an energy of the pulsed laser beam,
changing a laser contrast,
changing laser pulse width,
changing a pulse energy,
changing a focal spot shape,
changing an intensity distribution,
changing a wavefront.

By this training, the apparatus or particle accelerator can be stabilized at peak performance. According to embodiments, this training or optimization can be done by using passive detection methods like analyzing the mentioned emitted gamma radiation, emitted plasma radiation or looking at the laser near field, far field, pulse shape, laser energy etc.

This method or part thereof may also be implemented in software, or as a computer program product and the order of steps may not be important to achieve the desired effect. Therefore, embodiments relate also to a computer program product having a program code for performing the method, when the computer program is executed on a processor or to a machine-readable storage medium characterized by having instructions codes stored therein adapted to perform the steps of the method, wherein said instructions codes are executed on a computer or processor. In particular, the method implemented in software may control the apparatus as described herein to perform the steps of a method as described before.

Embodiments overcome the problems of the conventional systems or methods by possibly using of multiple pre-pulses, which can be controlled separately in terms of their time interval to the main pulse and/or their intensity. This allows several arbitrary expansion profiles to be superimposed in order to generate a large number of different plasma density profiles (e.g., of electrons and ions). This allows, in particular, modulations to be applied to the density profile or longer areas with a flat gradient to be maintained close to the optimum density parameters as it will be described in more detail below.

To achieve the optimal parameters, embodiments use an automated feedback loop to monitor the efficiency of the ion or electron acceleration and to correlate it with the incoming laser and pre-pulse parameters. Through this process, the entire parameter space is examined and automatically analyzed using an optimization algorithm to find the most efficient combination of laser and target parameters and corresponding pre-pulses. The optional use of a neural network machine makes this process even faster and more efficient, and the acceleration process can be kept stable at an optimum level at the same time.

Optionally the same process can be used to optimize for x-ray and gamma radiation emission.

Embodiments can be utilized to optimize radiation types of radiation such as ions, electrons and high energy photons (e.g., X-rays, gamma-rays) from bremsstrahlung inside the target. Gamma photons can be emitted from overdense targets.

Embodiments provide the following advantages:
A higher conversion efficiency is achieved, and thus more particles are accelerated. This is important because a doubling in the conversion efficiency in a fusion power plant corresponds to halving the required short-pulse laser energy and thus the number of lasers required.
A higher conversion efficiency in a laser-driven neutron, proton or x-ray source is directly proportional to the production of the desired radiation type. A doubling in conversion efficiency therefore halves the required analysis time for a given application. Comparable methods have shown a 6-fold increase in conversion efficiency. With this improved method, an increase of 10-20 times can be expected, depending on the initial parameters.
A higher maximum energy can also be achieved, which has a significant effect on the efficiency of laser neutron sources. Higher maximum energies of ions significantly increase the conversion rate from protons to neutrons and therefore the source performance.
By using multiple pulses with different heights, significantly larger modifications of the pre-plasma gradient profile can be generated, which is crucial for the coupling of laser energy into ion energy. Using a single pre-pulse limits the plasma density gradient at the target front surface to a hydrodynamic expansion profile, which is limited by the underlying physics in its gradient profile. Multiple pulses can superimpose multiple expansion profiles and the laser pressure can also modify the density gradient of previous expansions.
By using an optimization algorithm or a neural network with direct influence on the control of the pre-pulses and the laser parameters, the optimum operating point can be set automatically and much faster than by manual adjustment.

### BRIEF DESCRIPTION OF THE DRAWINGS

Various embodiments of the present invention will be described in the following by way of examples only, and with respect to the accompanying drawings, in which:

FIG. 1 depicts an apparatus for optimizing an optical energy transfer in a laser ion acceleration according to an embodiment.

FIG. 2 depicts the apparatus according to another embodiment with further optional components.

FIGS. 3A, 3B depict further embodiments of the apparatus illustrating temporal distances between pre-pulses and the main pulse.

FIGS. 4A-4C show the laser contrast with introduced pre-pulses and the pre-plasma shaping as achieved by embodiments.

FIG. 5 shows an embodiment of a system with the apparatus that can be utilized to optimize the energy transfer.

FIG. 6 depicts a schematic flow chart of a method for optimizing an optical energy transfer in a laser ion acceleration according to an embodiment.

FIG. 7 illustrate advantages achievable by embodiments.

### DETAILED DESCRIPTION

Various examples will now be described more fully with reference to the accompanying drawings in which some examples are illustrated.

Accordingly, while examples are capable of various modifications and alternative forms, the illustrative examples in the figures will herein be described in detail. It should be understood, however, that there is no intent to limit examples to the particular forms disclosed, but on the contrary, examples are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing illustrative examples only and is not intended to be limiting. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements and/or components, but do not preclude the presence or addition of one or more other features, steps, operations, elements, components and/or groups thereof.

Unless otherwise defined, all terms (including technical and scientific terms) used herein have the same meaning as commonly understood by one of ordinary skill in the art to which examples belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

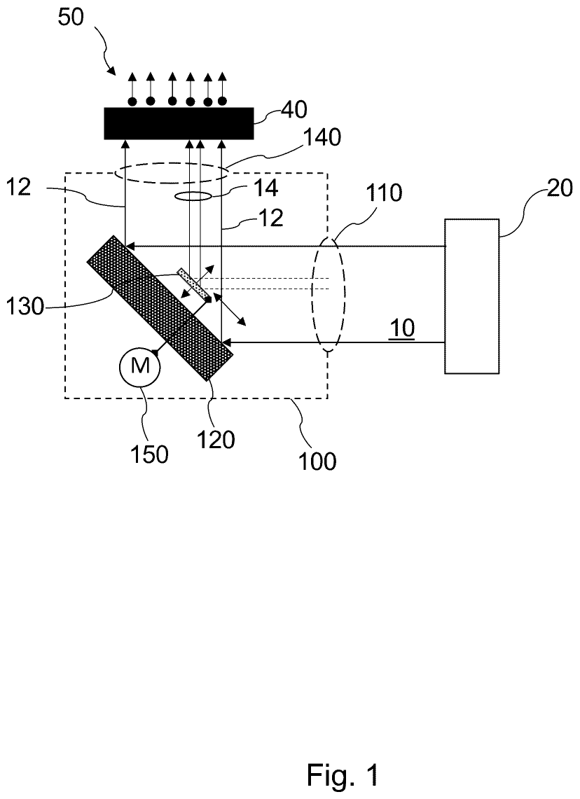

FIG. 1 depicts an apparatus 100 for optimizing an optical energy transfer in laser ion acceleration according to an embodiment. The apparatus 100 includes an optical input 110, an optical output 140, a primary mirror 120, a secondary mirror 130, and a moving device 150. The dashed line for the apparatus 100 shall indicate that these components may be integrated into an optional housing, but do not have to be accommodated in a case or housing. Thus, the optical input/output do not need to involve any structural feature but may define merely a propagation direction of the pulsed laser beam (namely from the input to the output).

Therefore, the apparatus 100 receives through the optical input 110 a pulsed laser beam 10 generated by a laser source 20. The laser beam 10 is reflected by the primary mirror 120 and, part thereof, by the secondary mirror 130. The part(s) of the pulsed laser beam 10 reflected by the secondary mirror 130 represent pre-pulses 14 and the reflected portion of the main mirror 120 are the main pulses 12. The main pulses 12 and the pre-pulses 14 are transmitted through the optical output 140 to a target 40, to generate a plurality of accelerated particles 50 (for example protons or electrons). The pre-pulses 14 travel a shorter optical length through the apparatus 100 and thus arrive earlier at the target 40 when compared to the main pulses 12.

Although FIG. 1 shows only a single secondary mirror 130, the apparatus 100 may include multiple secondary mirrors 130, e.g. to generate for each main pulse 12 multiples pre-pulses 14. However, the multiple pre-pulses 14 can also be generated by a single secondary mirror 130 with multiple reflection planes (e.g. formed as a layer structure or in a stepped way).

The moving device 150 is configured to adjust optical length difference for the pre-pulses 14 and the main pulses 12 and therewith adjusts the temporal difference between the pulses upon arrival at the target. To achieve this, the moving device 150 may vary a distance between the secondary mirror 130 and the primary mirror 120 in a normal or a perpendicular direction of reflective surface of the primary mirror 120. As a result, pulses reflected at the secondary mirror 130 travel a shorter optical path between the optical input 110 and the optical output 140 when compared to pulses reflected at the primary mirror 120. Therefore, the pre-pulses 14 leave the optical output 140 prior to the main pulses 12. The duration between the pre-pulses 40 and the main pulses 12 can thus be adjusted by utilizing the moving device 150. The mirror 130 can also move parallel to the mirror surface 120 to move outside the beam path of 12, enabling 120 to be fully covered, partly covered or not covered at all and therefore reflecting less laser light from 12 down to none at all to change the pre-pulse intensity.

According to embodiments, the moving device 150 includes suitable drives (e.g. moveable axes) to move the secondary mirror 130 perpendicular and/or parallel to the reflecting surface of the mirror 120. Likewise, although FIG. 1 shows only a single secondary mirror 130 a proper plasma shaping may need multiple secondary mirrors 130 to generate for each main pulse 12 multiple pre-pulses 14. According to embodiments, as will be seen in the following, the pre pulses 14 are inserted or generated in multiple ways and can arrive at the target 40 between 100 ns to 2 ps before the main pulse 12.

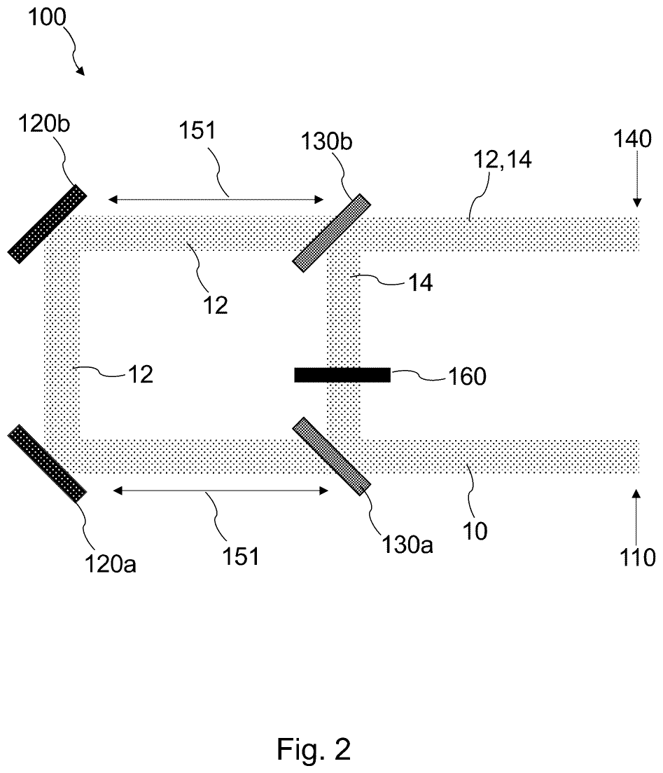

FIG. 2 depicts the apparatus 100 according to another embodiment. In this embodiment the apparatus 100 includes a first primary mirror 120a and a second primary mirror 120b. In addition, the apparatus 100 includes a first secondary mirror 130a and a second secondary mirror 130b, wherein an absorber 160 is arranged between the first secondary mirror 130a and the second secondary mirror 130b. The secondary mirrors 130a, 130b are configured as semi-permeable (semi-transparent) mirrors so that one portion of the incident light is reflected by the secondary mirrors 130a, 130b and another portion is transmitted through the secondary mirrors 130a, 130b to the primary mirrors 120a, 120b and an optical output 140, resp.

The absorber 160 may be configured to adjust an absorption ratio for the part of laser beams passing through the absorber 160. Therefore, the intensity of the pre-pulses 14 received from the first secondary mirror 130a can be adjusted utilizing the adjustable absorber 160 when travelling towards the second secondary mirror 130b. A maximal possible intensity of the pre-pulses 14 is set by the degree of semitransparency of the first secondary mirror 130a which may be selected accordingly.

Again, at the optical input 110 the apparatus 100 receives the pulsed laser beam 10 from a laser source which is first received by the first secondary mirror 130a, where a portion of the pulsed laser beam 10 is reflected as pre-pulses 14 towards the absorber 160. The portion which is not reflected by the secondary mirror 130a is passing through the first secondary mirror 130a to hit, as main pulses 12, the first main mirror 120a, where the main pulses 12 are reflected towards the second main mirror 120b, where in turn the main pulses 12 is reflected towards the second secondary mirror 130b. The semipermeable second secondary mirror 130b is transparent for received main pulses 12 and reflective for received main pulses 14, which, thereafter, both leave the apparatus 100 at the optical output 140. The second secondary mirror 130b may have an anti-reflective coating on the side where the main pulses 12 are received.

According to the depicted embodiment, the distance along the optical path between the secondary mirrors 130a, 130b and the distance between the primary mirrors 120a, 120b may be fixed, whereas a distance between the first secondary mirror 130a and the first primary mirror 120a forms a first delay line 151 that can be adjusted by the moving device 150 (not shown in FIG. 2). Similarly, the moving device 150 may adjust a second delay line 152 being a distance between the second secondary mirror 130b and the second primary mirror 120b. The first/second delay lines 151, 152 delay the main pulses 12 behind the pre-pulse 14.

By varying the first delay line 151 and/or the second delay line 152 the detour of the main pulses 12 via the primary mirrors 120a, 120b can be adjusted. In other words, the lead of the pre-pulses 14 over the main pulses 12 or the temporal distance between the pre-pulses 14 and the main pulses 12 can be (continuously) changed. For the specific embodiment depicted in FIG. 2, the pulsed laser beam 10 travels along rectangular optical paths, wherein the pre-pulses 14 travel a significantly shorter optical length when compared to the main pulses 12 which have to be reflected by the main mirrors 120a, 120b. Therefore, this embodiment is of advantage if larger temporal distances between the pre-pulses 14 and the main pulses 12 are desired.

According to further embodiments, one or more additional secondary mirrors as described in FIG. 1 can be arranged in front of the primary mirrors 120a, 120b which is particularly suitable to set smaller temporal distances.

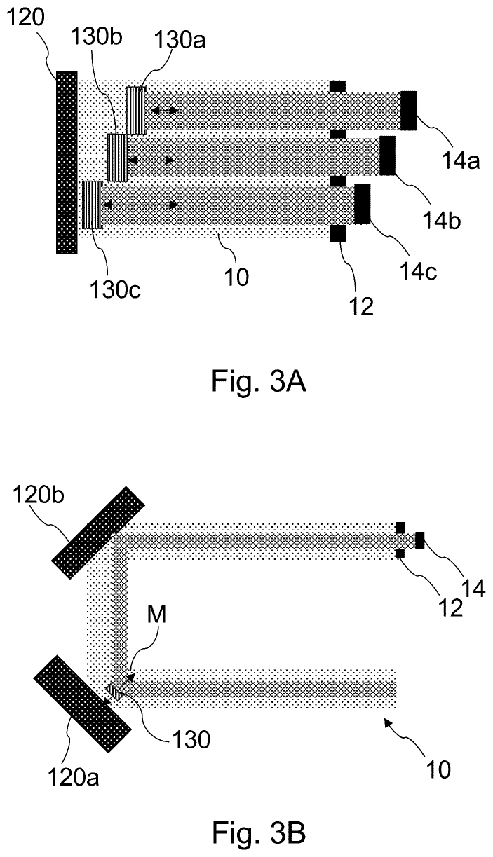

FIGS. 3A and 3B depict further embodiments of the apparatus 100. According to the embodiment of FIG. 3A, the incident pulsed laser beam 10 travels in an opposite direction as the reflected main pulses 12 and pre-pulses 14. This is achieved in that the main mirror 120 is arranged perpendicular to the propagation direction of the pulsed laser beam 10 and by arranging the secondary mirrors 130a, 130b, 130c parallel to the main mirror 120. According to this embodiment, multiple secondary mirrors 130a, 130b, 130c (e.g. the depicted three) are arranged at different distances from the main mirror 120 and laterally be spaced from one another.

Each of the secondary mirror 130a, 130b, 130c may be independently movable by the moving device 150 (not shown in FIG. 3A). As a result, three exemplary pre-pulses 14 are generated: a first pre-pulse 14a by the first secondary mirror 130a, a second pre-pulse 14b by the second secondary mirror 130b, and a third pre-pulse 14c by the third secondary mirror 130c. According to the different distances of the secondary mirrors 130a, 130b, 130c from the main mirror 120, the first pre-pulse 14a is the first pre-pulse leaving the apparatus 100, the second pre-pulse 14b is leaving the apparatus 100 at a second position and the third pre-pulse 14c is the last pre-pulse 14 leaving the apparatus 100 before the main pulse 12 will leave the apparatus 100. These time-like distances between the pre-pulses 14 and the main pulse 12 are indicated by the length of the shadowed optical paths of the laser beams. Furthermore, in this embodiment, the parallel optical paths of the pre-pulses 14 is inside a wide optical path of main pulse 12. All optical paths of the pre-pulses 14 cover a smaller area than the optical path of the main pulse 12.

According to this embodiment, the secondary mirrors 130a, 130b and 130c can again be formed as semi-permeable mirrors implying that they reflect only a portion of the received pulsed laser beam 10, wherein the reflected portion generates the respective pre-pulses 14a, 14b, 14c. However, the secondary mirrors 130a, 130b and 130c can likewise be formed as opaque mirrors implying that they reflect all received laser light. In the latter case, the lateral size (cross-sections) of the secondary mirrors 130a, 130b and 130c may be formed significantly smaller than the main mirror 120 to leave a sufficient intensity for the main pulse 12. Here it is also possible to partly remove 130a-c out of the main beam to change the pre-pulse intensity by having a smaller part of the laser beam reflected.

According to further embodiments, the direction of the incident pulsed laser beam 10 can be different (i.e. not along the normal direction of the primary mirror 120). For example, the primary mirrors 120a, 120b of FIG. 2 can be combined with multiple secondary mirrors 130a, 130b, . . . as described in the embodiment of FIG. 3A.

FIG. 3B shows another embodiment of the apparatus 100 including a first primary mirror 120a, a second primary mirror 120b and one secondary mirror 130. In this embodiment the secondary mirror 130 is arranged in front of the first primary mirror 120a in a variable distance or gap from the primary mirror 120a (as measured along a normal direction of the mirror planes). The distance can again be adjusted by the moving device 150 (not shown in this figure) which will produce the desired temporal delay. The secondary mirror 130 can again be semipermeable (but does not need to be semipermeable) and the second primary mirror 120b may reflect all light towards the optical output, i.e. the main pulse 12 as well as the pre-pulses 14. Again, the length of the optical paths will result in a lead of the pre-pulse 14 over the main pulse 12 at the optical output 140.

In addition, the secondary mirror 130 may be moved partly out of the laser beam 10 by a movement parallel to the reflective surface of the first primary mirror 120a. Thus, the pre pulse intensity can be adjusted by reflecting a smaller portion of the light. By moving back, the intensity will increase again.

As for the embodiment of FIG. 3, the optical path the optical paths of the pre-pulses 14 are the same or inside the optical path of main pulse 12. The main pulse 12, however, has a temporal delay.

It is understood, although FIG. 3B and FIG. 2 both show devices to create a single pre-pulse it is possible to create any number of pre-pulses 14 for each main pulse 12. This can be achieved by adding more than one secondary mirror 130 in front of the first primary mirror 120a and/or the second primary mirror 120b. The importance of multiples pre-pulses 14 will be described below.

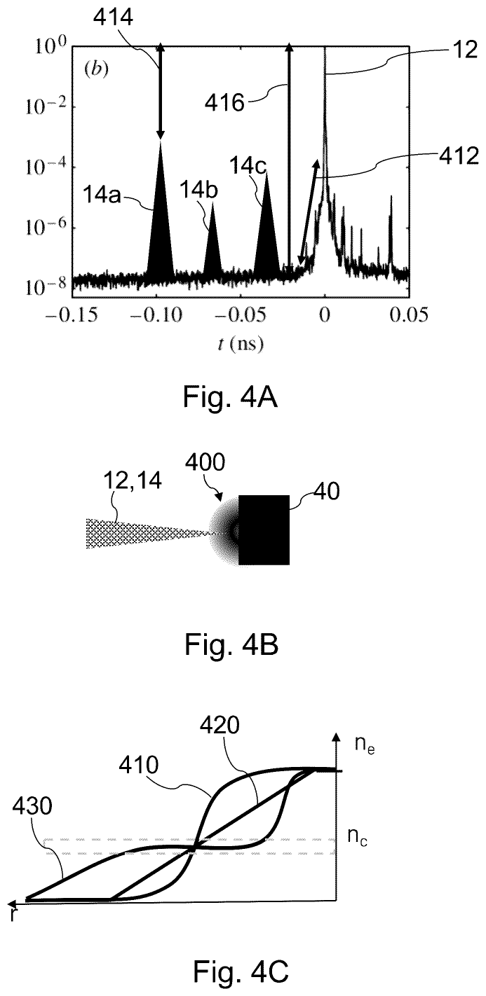

FIGS. 4A to 4C illustrate the technical effect achieved by embodiments, namely a pre-plasma shaping by suitably inserted and adjusted pre-pulses 14.

FIG. 4A illustrates definitions of the pre-pulse contrast 414 as pulsed traveling ahead of a main pulse 12, amplified spontaneous emission (ASE) contrast 416 and a rising edge 412. According to embodiments, two, three, four or more pre-pulses 14 can occur and can used for ionizing the target 40. However, at first, it should be appreciated that the light from ASE or from the rising edge 412 of the main pulse 12 will be generated in a generic scenario of laser driven ion acceleration. However, the pre-pulses 14 can ionize the target 40 before the main pulse 12 arrives (e.g. with an intensity of >10¹⁸ W/cm²).

As set out before, each of their difference in arrival time before the main pulse 12 and their height can be adjusted independently. Concretely, the main pulse 12 arrives at time t=0 at the target 40 and three exemplary pre-pulses 14 arrive at earlier times at the target 40. For example, a first pre-pulse 14a arrives at a time −0.1 nanoseconds, a second pre-pulse 14b arrives at a time about −0.07 nanoseconds, and a third pre-pulse 14c arrives at the target at a time about −0.03 at the target 40 prior to the arrival of the main pulse 12 at t=0.

According to embodiments, the pre-pulses 14 may have adjusted intensities (height of the shown peaks) defining a pre-pulse contrast 414 as the attenuation compared to the main pulse 12. The attenuation of the floor area compared to the main pulse 12 defines the ASE contrast 416. By controlling the moving device 150 and therewith the arrival time of the pre-pulses 14, and/or the absorption rate of the absorber 160, the intensity of each pre-pulse 14 and thus the pre-pulse contrast 414 can be adjusted in accordance with the needs in the optimization. The main pulse 12 can be characterized by its rising edge 412 parameterizing the intensity increase from a ground toward its maximal intensity, which is normalized to “1” in FIG. 4A.

FIGS. 4B and 4C illustrate the pre-plasma shaping which is utilized in embodiments. If the target 40 is ionized, then the plasma is heated up and pre-expands before the main pulse 12 arrives. This causes a hydrodynamic expansion gradient 400 (pre-plasma) of the target front side as shown in FIG. 4B. Before the laser interaction, the target 40 has an electron density of a solid object around 10²³ e/cm³ in the target 40 and the density is zero outside the target 40. FIG. 4C shows the electron density n_e as function of the radius r in front of the target 40 measured from the point of impact of the pulses 12, 14.

After ASE irradiation the electron density n_e looks like a first curve 410. If now the main pulse 12 arrives, the laser can propagate through the area where n_e is smaller than the critical density n_c. The closer the laser gets to the target, the higher n_e gets. Once n_e is larger than n_c, then the plasma becomes reflective, and the laser cannot longer propagate though the target 40 and is instead reflected (or at least part thereof). Around the critical density n_c, the laser can effectively couple its laser energy to heat the target, which is subsequently needed to accelerate ions 50. This area is typically very narrow in most cases.

If now a single pre-pulse 14 or a shape control of the rising edge is used, then only an adiabatic expansion profile can be created, where only a small area covers the critical density n_c (see second curve 420), where the steadily decreasing density curve 420 is inside the range of critical density n_c. The gradient here is again defined by the physical expansion of the heated plasma by the first pre-pulse. This slightly target area close to n_c increases conversion efficiency but the limited distance close to n_c limits the conversion efficiency in laser ion acceleration. Therefore, when methods utilize only a single pre-pulse, this allows only a certain form of pre-plasma expansion.

However, if the expansion of the plasma is modified to have multiple pre-expansions of the plasma (e.g. by introducing multiple pre-pulses 14), this can lead to a larger area of plasma 400 with the critical density n_c as illustrated by a third curve 430, which is flat inside the area of critical density n_c. Thus, this increases the conversion efficiency of laser energy into kinetic ion or electron energy. With more energy coupled to the plasma, higher particle energies become possible, and more particles are accelerated. As consequence, embodiments utilize multiple pre-pulses 14 the pre-plasma 400 to shape a large area of critical density n_c resulting in an optimal energy transfer.

Therefore, by using multiple pre-pulses 14 with the correct intensity and/or timing multiple overlapping expansion profiles can be created that form as superposition the desired critical density n_c in a large region (see extended flat portion of the third curve 430).

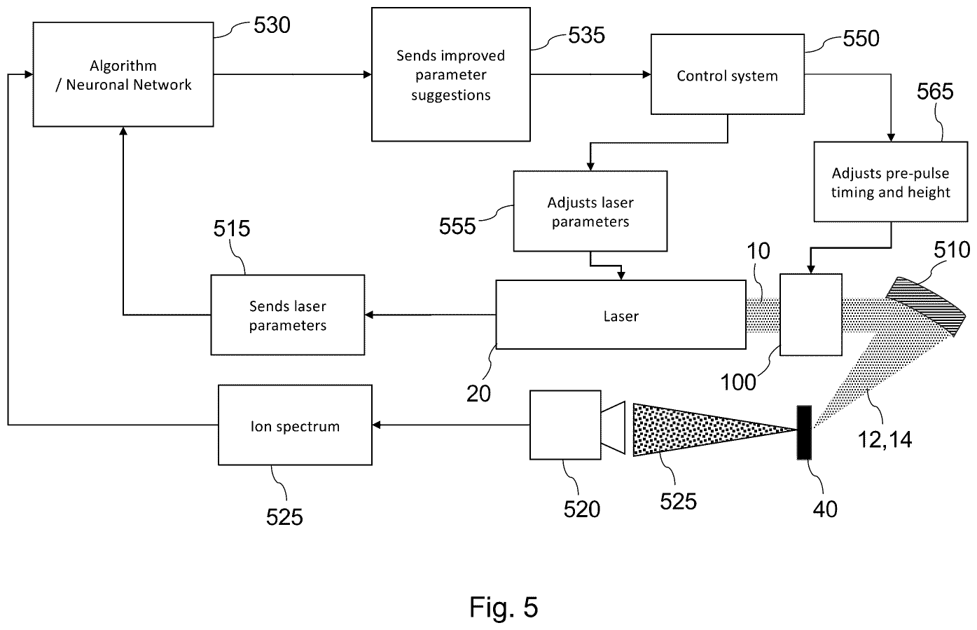

FIG. 5 shows a system which can be utilized to optimize the optical energy transfer in laser ion acceleration. The system includes the laser source 20, the apparatus 100, the target 40, where the plurality of ions 50 are generated. In addition, the system includes an optional focusing device 510 and a detector 520. The focusing device 510 may be a parabolic mirror and focusses the pre-pulses 14 and main pulse 12 towards the target 40, where the pulses 12, 14 generate and accelerate particles 50 such as ions which are detected by the particle detector 520.

The optional focusing device 510 may also be arrange in the embodiment shown in FIG. 1, for example after exiting the apparatus 100 so that also for that embodiment both, the pre-pulses 14 and the main pulse 12, can hit the focusing device 510 (e.g. a parabolic mirror) and are focused down to the same spot. As result, the main pulse 12 as well as the pre-pulses 14 will irradiate the same area.

In addition, the system includes a neural network machine 530 with a machine-learning algorithm and a control device 550. The neural network machine 530 receives a spectrum 525 of the ions detected by the particle detector 520. In addition, the neural network 530 receives laser parameters 515 from the laser source 20 and the positions of all pre-pulse shaping devices. Based on this input, the neural network machine 530 generates improved parameters 535 which are transmitted to the control device 550. The control device 550 uses the improved parameters 535 to set or vary at least one of the following:
the laser parameters 555,
the timing 565 of pre-pulses 14,
height or intensity 565 of the pre-pulses 14.

The timing 565 is modified by controlling the moving device 150 to adjust the temporal distances of the pre-pulses 14 to the main pulse 12. The height or intensity 565 (or pre-pulse contrast 414) is modified by controlling the absorber 160 in the apparatus 100.

This system represents a closed feedback loop, wherein the laser parameters 555 and the timing/height parameter 565 are optimized for so long until the particle detector 520 detects a desired spectrum for the accelerated ions 50 (e.g. with maximum energy). In particular, the neural network machine 530 can be used as a learning algorithm to optimize the parameter settings for a given laser source 20 and a given target 40 to provide an optimized energy transfer from the laser source 20 to the accelerated ions 50.

In particular, the neuronal network machine 530 is trained to supervise the system of FIG. 5 to speed up the optimization process (e.g. by quickly achieving an electron density n_e with a maximal length in the region of critical density n_c; see FIG. 4C). For this, the neuronal network machine 530 may, optionally, observe all relevant laser diagnostic tools to find parameters that have an influence on the acceleration process. The neural network machine 530 can subsequently send commands to the laser control system 550 as well as to the moving device 150 to adjust the pre-pulse delay lines 151, 152 to optimize the acceleration process.

Thus, according to embodiments, the feedback system of FIG. 5 measures the ion acceleration efficiency and may statistically vary the delay(s) between the pulses 12, 14 and/or the pulse intensities as parameters to find optimized parameter. In this optimization, the neural network machine 530 is trained to implement one or more of the following:
evaluate an available parameter space,
finds optimal parameters,
uses the feedback loop to maximize or optimize the performance of the ion acceleration.

As already mentioned, in this performance optimization, one or more of the following parameters may be observed and varied: laser contrast, laser pulse width, pulse energy, focal spot shape, intensity distribution, wavefront, laser near field, laser far field, other parameters.

The corresponding measurement for the diagnose of the accelerated ions 50 can be performed by the detector 520 (or ions or particles) that may be adapted to perform a spectral analysis for the particle/ion beam 50 to give an automated feedback to the neural network machine 530 as analysis system and may provide information for each shot or groups of shots of ions in combination with other diagnostics that measure the ion spectrum, the conversion efficiency, or parasitic parameters like the gamma emission from the interaction of the laser target 40 which can be correlated to the ion acceleration if necessary.

According to embodiments, the system is trained to detect shifts in the performance of the laser parameters and plasma interaction to actively compensate for that. This may be used to stabilize the system at peak performance. This can be done by using passive detection methods like analyzing the emitted gamma radiation, emitted plasma radiation or looking at the laser near field, far field, pulse shape, laser energy etc.

Embodiments may utilize or implement various neural networks in or as the neural network machine 530. For example, the neuronal network machine 530 includes or is a supervised neural network. This provides the advantage of speeding up the optimization process. Alternatively, or additionally, the neural network machine can also be used to operate as an active stabilization method for the laser particle acceleration.

According to embodiments, the neural network machine 530 uses Bayesian optimization with a Bayesian neural network (BNN) as they can be used to build a surrogate model. This model can approximate the complex relationship between the input parameters (mirror positions, pre-pulse intensity, delay, etc.) and the output (number of accelerated ions or electrons). The neural network machine 530 should take the input parameters as input and may output the predicted number of particles (ions, electrons).

The surrogate model can then be used to guide the next set of parameters to evaluate. The Bayesian optimization typically employs acquisition functions (e.g., Expected Improvement, Upper Confidence Bound) to balance exploration and exploitation. The neural network surrogate model enables the efficient calculation of these acquisition functions. Embodiments utilize this Acquisition Function Optimization.

Likewise, embodiments use Bayesian Update as follows. After evaluating an objective function (e.g., the number of accelerated ions) for a new set of parameters, the surrogate model may be updated using Bayesian inference techniques. This allows the surrogate model to incorporate the new information and refine its predictions.

Advantageously, the Bayesian optimization excels in scenarios where the objective function (e.g., the number of accelerated ions) is expensive to evaluate. By intelligently selecting the next set of parameters to evaluate based on the surrogate model's predictions, the Bayesian optimization efficiently explores the parameter space. This reduces the number of experiments needed to find the optimal solution.

According to further embodiments, the neural network machine 530 may include a convolutional neuronal network and/or a recurrent neural network. The convolutional neuronal networks may be used to evaluate the information on the laser near and far field, while the recurrent neural networks can be used to increase the performance for long term time shifts.

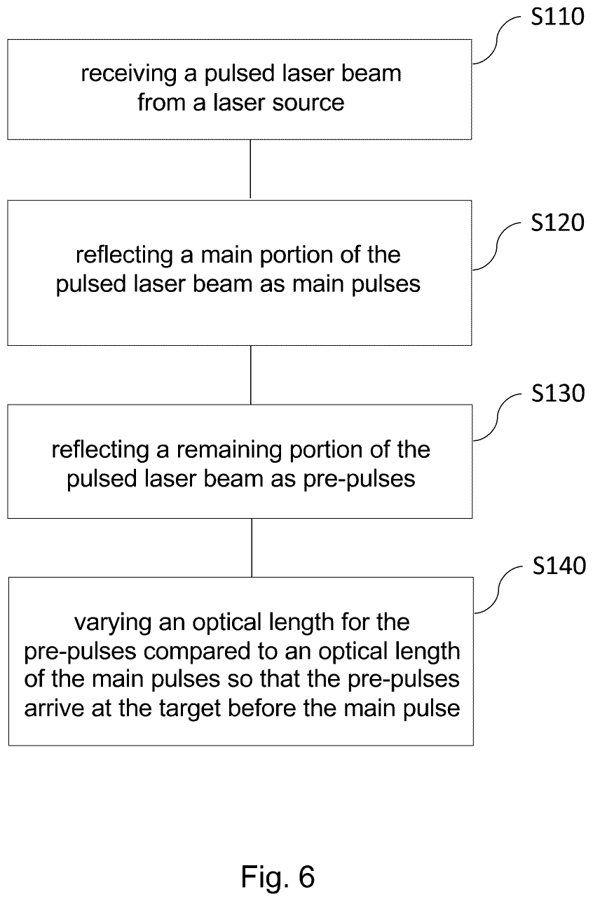

FIG. 6 depicts a schematic flow chart of a method for optimizing an optical energy transfer in a laser ion acceleration according to an embodiment. The method comprises the steps of:
receiving S110 a pulsed laser beam 10 from a laser source 20;
reflecting S120 (e.g. by a primary mirror 120 arranged in an optical path of the pulsed laser beam 10) a main portion of the pulsed laser beam 10 as main pulses 12;
reflecting S130 (e.g. by at least one secondary mirror 130 arranged in the optical path of the pulsed laser beam) a remaining portion of the pulsed laser beam as pre-pulses 14; and
varying an optical length for the pre-pulses 14 compared to an optical length of the main pulses 12 so that the pre-pulses 14 arrive at the target 40 before the corresponding main pulse 12 (to optimize the optical energy transfer to ions accelerated from the target 40).

Of course, the order of steps can be different. For example, the step of reflecting S130 of the pre-pulses 14 can be carried out before the step of reflecting the main portion. Furthermore, the step of varying the optical length can be achieved by moving (e.g., by a moving device 150) the at least one secondary mirror 130 relative to the primary mirror 120.

According to further embodiments, this method can also be used to operate as an active stabilization method for the laser particle acceleration.

According to further embodiments, again multiple pre-pulses 14 are introduced into the laser contrast with changing or adjusted the temporal distance to the main pulse 12 and/or their intensity to enhance laser absorption in laser-driven ion acceleration and increase conversion efficiency and peak particle energy.

According to further embodiments, an optimization or maximization of the conversion efficiency is performed by using a digital particle detector as a feedback loop combined with an optimization algorithm or neuronal network machine (cp. FIG. 5) that scans the parameter space and optimizes the parameters for peak performance automatically.

This method or at least part thereof (e.g., the optimization) may also be a computer-implemented method. A person of skill in the art would readily recognize that various steps of the described method may be performed by programmed computers. Thus, embodiments are also intended to cover program storage devices, e.g., digital data storage media, which are machine or computer readable and encode machine-executable or computer-executable programs of instructions, wherein the instructions perform some or all of the acts of the above-described methods or control the apparatus to perform the method as described before, when executed on the computer or processor. In particular, the simulation as set out before to find out optimal sizes and optimal transparencies for the secondary mirrors 130 can be implemented on a computer.

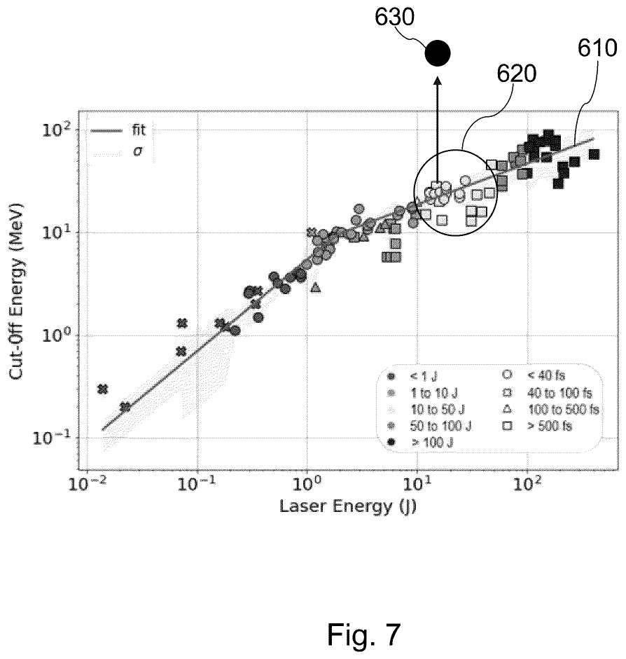

FIG. 7 illustrates the advantages achievable by embodiments of the present invention. It shows the (cut-off) energy of the accelerated particles (e.g. ions) as function of the laser energy and thus shows the efficiency of the energy transfer. The depicted curve 610 shows the maximal achievable particle energy without control of the pre-pulses for different laser energy ranges. For the laser energy range 620 between 10 J to 50 J, the influence of the pre-pulse control according to embodiments has been tested with the result that the maximal particle energy has been increase from about 10 . . . 12 MeV to 140 MeV, i.e. by a factor or more than 10. Therefore, embodiments provide a significant improvement over the conventional laser ion acceleration.

To achieve this effect, the various embodiments utilized one or more or the following technical features:
use multiple pre-pulses 14,
control their height or intensity of the pre-pulses 14,
control temporal distance of the pre-pulses 14 to the main pulse 12
create multiple overlapping expansion profiles.

This way it is possible to tailor a plasma density profile as it was described with FIGS. 4A-4C that in turn is matched to the optimal laser absorption conditions instead of being limited by the density profile of the natural expansion of the plasma from a single pre-pulse. In particular, the multiple pre-pulses 14 produce upon the controlling an overlapping density profile of multiple expansion profiles a needed density profile (close to the critical density n_c). The usage of the radiation pressure of pre-pulses 14 on the pre-plasma 400 tailors the density profile as well.

According to the described embodiments, the pre-pulses were created by multiple ways:
(i) One option was (see e.g. FIG. 2) that one or more semi-transparent larger secondary mirrors 130 are used and combined with a movable delay line 151, 152 and/or an adjustable absorber 160 and/or reflectors (primary mirrors 120).
(ii) Another option was to add smaller secondary mirrors 130 (e.g. opaque mirrors) in the beam path parallel to another primary mirror 120. This, too, creates a smaller beam that will arrive earlier on the target 40 (see FIGS. 1, 3A, 3B). Here the intensity can be changed by varying the size of the small mirror, its emersion in the main beam 12 or its reflectivity. The delay of the pre-pulse 14 was adjusted by increasing the distance between the reflective surfaces of the small (secondary) mirror(s) 130 and the large (primary) mirror 120.

Embodiments utilizes the method to increase the conversion efficiency of laser energy into particle radiation in the laser particle acceleration process. This is done by modifying the spatial and temporal course of the pre-plasma during laser particle acceleration in a way that is optimal for the process.

The advantage of this method is that the course of the pre-plasma can be influenced almost arbitrarily or in many parameters, whereas previous approaches could only generate an adiabatic plasma expansion with a physically predefined density curve. This predefined curve does not allow any modulation of the plasma density curve.

Embodiments enable to adjust the spatial course of the pre-plasma (pre-plasma shaping) in such a way that the spatial range of the optimal laser coupling is enlarged and thus the conversion efficiency is increased. It is also possible that the rear side of the target 40 is not disturbed during the process as this would impair the ion acceleration process. This spatial shaping is not possible in conventional laser ion acceleration.

The description and drawings merely illustrate the principles of the disclosure. It will thus be appreciated that those skilled in the art will be able to devise various arrangements that, although not explicitly described or shown herein, embody the principles of the disclosure and are included within its scope.

Furthermore, while each embodiment may stand on its own as a separate example, it is to be noted that in other embodiments the defined features can be combined differently, i.e. a particular feature descripted in one embodiment may also be realized in other embodiments. Such combinations are covered by the disclosure herein unless it is stated that a specific combination is not intended.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

10 pulsed laser beam
12 main pulse(s)
14 pre-pulse(s)
20 laser source
40 target
50 ions (protons, electrons, neutron, nuclei)
100 apparatus
110 optical input
120 primary mirror(s)
130 secondary mirror(s)
140 optical output
150 moving device
151, 152 delay lines
160 absorber (e.g. controllable)
400 pre-plasma
410, 420, 430 electron-densities
412 rising edge of main pulse
414 pre-pulse contrast
416 ASE contrast
510 focusing device
515 laser parameter(s)
520 (particle/ion) detector
525 (ion) spectrum
530 neural network machine (machine-learning algorithm)
535 improved parameters
550 control device
555 modified laser parameters
565 modified timing/height of the pre-pulses

What is claimed is:

1. An apparatus for optimizing an optical energy transfer in laser particle acceleration, the apparatus comprising:
an optical input for receiving a pulsed laser beam from a laser source;
a primary mirror arranged in an optical path of the pulsed laser beam to reflect a main portion of the pulsed laser beam as main pulses;
at least one secondary mirror arranged in the optical path of the pulsed laser beam to reflect a remaining portion of the pulsed laser beam as pre-pulses; and
a moving device adapted to move the at least one secondary mirror relative to the primary mirror to vary an optical length travelled by the pre-pulses compared to an optical length travelled by the main pulses to allow the pre-pulses to arrive at the target before the main pulses to optimize the optical energy transfer to ions accelerated from the target.

2. The apparatus according to claim 1,
wherein the at least one secondary mirror is semitransparent and is arranged to receive the pulsed laser beam from a first direction and to reflect the pre-pulses in a second direction,
and wherein the main pulses pass through the semitransparent secondary mirror to propagate along a delay line formed between the primary mirror and the at least one secondary mirror,
and wherein moving device is adapted to vary a length of the delay line.

3. The apparatus according to claim 2, further comprising an absorber arranged along the optical path of the pre-pulses, the absorber being adapted to adjust an intensity of the pre-pulses based on received control signals.

4. The apparatus according to claim 1,
wherein the at least one secondary mirror is opaque, and
wherein the pulsed laser beam has a cross-sectional area which larger than a cross-section of the at least one secondary mirror in the optical path of the pulsed laser beam.

5. The apparatus according to claim 1, wherein
the primary mirror reflects the main pulses in a direction of incidence of the pulsed laser beam or in a predetermined reflection angle; and
the at least one secondary mirror reflects the pre-pulses in the direction of incidence of the pulsed laser beam or in the predetermined reflection angle.

6. The apparatus according to claim 5, wherein the at least secondary mirror comprises multiple secondary mirrors which are arranged in a cross-sectional area of the pulsed laser beam in front of the primary mirror so that the main pulses and the pre-pulses propagate along a same optical path.

7. The apparatus according to claim 1, further comprising a control device, the control device being adapted to control one or more of the following:
the source of the pulsed laser beam,
the moving device to move the at least one secondary mirror parallel and/or perpendicular to a reflecting surface of the primary mirror,
the absorber as defined in claim 3, to adjust at least one of the following
an intensity of the pulsed laser beam;
a frequency of pulses in the pulsed laser beam;
a delay between subsequent pulses;
adjust a timing of arrival of the pre-pulses at the target;
an intensity of the pre-pulses.

8. The apparatus according to claim 1, further including
a target adapted to release ions, electrons or high energy photons upon being hit by the pulsed laser beam; and
a spectrum analyzer adapted to determine a spectrum of the released radiation types.

9. The apparatus according to claim 8, further including a neural network machine adapted to increase the optical energy transfer in the laser ion acceleration by receiving as input
the determined spectrum of the released ions, and parameters from the laser source characterizing the pulsed laser beam,
and providing as output
improved parameters for the laser source, and
control signals to control the moving device and/or to control the adjustable absorber of claim 3.

10. The apparatus according to claim 9, wherein the neural network machined is trained to increase the optical energy transfer by preferring multiple pre-pulses for each main pulse and is trained to optimize an intensity and delays of the pre-pulses to achieve a flat or otherwise optimal electron density distribution near a critical electron density over a spatial region in front of the target.

11. The apparatus according to claim 9, wherein the neural network machine includes one or more of the following: a supervised neural network, a Bayesian neural network, a convolutional neuronal network, a recurrent neural network.

12. A particle accelerator comprising:
a laser source adapted to generate a pulsed laser beam;
an optical input for receiving the pulsed laser beam from the laser source;
a primary mirror arranged in an optical path of the pulsed laser beam to reflect a main portion of the pulsed laser beam as main pulses;
at least one secondary mirror arranged in the optical path of the pulsed laser beam to reflect a remaining portion of the pulsed laser beam as pre-pulses; and
a target arranged to receive the pre-pulses and the main pulses to generate ions, electrons or high energy photons.

13. A method for optimizing an optical energy transfer in laser acceleration of particles or X-rays or gamma radiation, the method comprising:
receiving a pulsed laser beam from a laser source;
reflecting, by a primary mirror arranged in an optical path of the pulsed laser beam, a main portion of the pulsed laser beam as main pulses;
reflecting, by at least one secondary mirror arranged in the optical path of the pulsed laser beam, a remaining portion of the pulsed laser beam as pre-pulses; and
moving, by a moving device, the at least one secondary mirror relative to the primary mirror to vary an optical length travelled by the pre-pulses compared to an optical length travelled by the main pulses to allow the pre-pulses to arrive at the target before the main pulses to optimize the optical energy transfer to ions accelerated from the target.

14. The method according to claim 13, wherein the step of reflecting the remaining portion includes: reflecting multiple pre-pulses by multiple secondary mirrors with different temporal distances to the main pulse or with different intensities.

15. The method according to claim 13, further including:
increasing a conversion efficiency by using a particle or radiation detector as a feedback loop combined with an optimization algorithm or neuronal network machine that scans the parameter space and optimizes the parameters for peak performance automatically.

16. The method according to claim 15, further including training the neural network machine to detect shifts in a performance of the parameters of the laser source and an interaction of the pre-pulses and the main pulses with a plasma generated at the target, wherein during the training at least one of the following is performed:
detecting emitted gamma radiation,
detecting emitted plasma radiation,
detecting a laser near field,
detecting a laser far field,
changing a pulse shape of the pulsed laser beam,
changing an energy of the pulsed laser beam,
changing a laser contrast,
changing laser pulse width,
changing a pulse energy,
changing a focal spot shape,
changing an intensity distribution,
changing a wavefront.

17. A machine-readable storage medium having instructions codes stored therein adapted to control an apparatus of claim 1 to perform the steps of a method according to claim 13, wherein said instructions codes are executed on a computer or processor.
